(19) United States
(12) Patent Application Publication
(10) Pub. No.: US 2007/0214484 A1
(43) Pub. Date: Sep. 13, 2007

(54) Digital video broadcast transition method and device

(76) Inventors: Carolyn Taylor, Chicago Heighs, IL (US); Yi Qiao, Hoffman Estates, IL (US); Theodore S. Rzeszewski, Wheaton, IL (US)

Correspondence Address: MOTOROLA INC, 600 NORTH US HIGHWAY 45, ROOM AS437, LIBERTYVILLE, IL, 60048-5343, US

(21) Appl. No.: 11/374,256

(22) Filed: Mar. 13, 2006

(51) Int. Cl. H04N 7/173; H04N 5/445; G06F 13/00; G06F 3/00; H04N 7/16

(52) U.S. Cl. 725/100; 725/131; 725/118; 725/54; 725/62

(57) ABSTRACT

A digital video broadcast transition method and device allows a streaming digital video program to be transferred from one broadcast receiver to another across digital video broadcast formats. Initially, a first digital video broadcast receiver is receiving a first program (210). If a second digital video broadcast receiver capable of receiving a digital video broadcast program corresponding to the first program is available to the user (220), the second digital video broadcast receiver is enabled (250). The transfer from one digital video broadcast receiver to another (240) can be implemented manually by the user or automatically via a user preference profile. The transition can be made gradually by having both receivers running simultaneously for a predetermined non-zero time period before releasing digital video broadcasting resources of the first device or can be made abruptly by setting the predetermined time period to zero seconds (260).

### FIELD OF THE DISCLOSURE

This disclosure relates generally to transitioning streaming digital video programs from one device to another.

### BACKGROUND OF THE DISCLOSURE

Next generation (4G) mobile devices are being designed to support heterogeneous access technologies such as Wireless Fidelity (WiFi), Universal Mobile Terrestrial System (UMTS), and Digital Video Broadcast-Handheld (DVB-H). Other access technologies may also be available through a 4G system but not necessarily available on a 4G mobile device. Such an example is Digital Video Broadcast-Terrestrial (DVB-T) service, which would be available on a digital DVB-T television or DVB-T receiver in a computer but not necessarily available on a digital mobile device.

If a user goes from an environment where one DVB service can be active on her devices (e.g., DVB-H on a mobile device while the user is walking down the street) to an environment where the other DVB service or both DVB services can be active on her devices (e.g., DVB-H on a mobile device and DVB-T on a digital television while the user is in her house), it would be beneficial to be able to determine the best available DVB device and transition the active DVB service to the best available device as desired (e.g., transition from a DVB-H service on the mobile device to a corresponding DVB-T service on the digital television). Conversely, if the user is leaving her home where a DVB-T news program is active on her digital television, it would be beneficial to be able to transition the DVB-T news program to a corresponding DVB-H news program on her mobile device as the user desires.

Thus, there is an opportunity to transition streaming digital video broadcast programming content from one device to another as desired by a user. Because the DVB-T system and the DVB-H system use different access technologies, there is a challenge to create smooth transitions such that a user can transfer the same program from DVB-T to DVB-H and vice versa without experiencing major delays that distract the user from enjoying the content itself. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a system for transitioning a digital video broadcast according to an embodiment.

FIG. 2 shows a general flow chart for transitioning a digital video broadcast according to an embodiment.

FIG. 3 shows a flow chart for user-initiated transitioning of a Digital Video Broadcast-Handheld (DVB-H) program on a User Equipment (UE) with a DVB-H receiver to a corresponding Digital Video Broadcast-Terrestrial (DVB-T) program on a DVB-T device according to an embodiment.

FIG. 4 shows a flow chart for automatically-initiated transitioning of a Digital Video Broadcast-Handheld (DVB-H) program on a User Equipment (UE) with a DVB-H receiver to a corresponding Digital Video Broadcast-Terrestrial (DVB-T) program on a DVB-T device according to an embodiment.

FIG. 5 shows a flow chart for user-initiated transitioning of a Digital Video Broadcast-Terrestrial (DVB-T) program from a DVB-T device to a corresponding Digital Video Broadcast-Handheld (DVB-H) program on a DVB-H device according to an embodiment.

FIG. 6 shows a flow chart for automatically-initiated transitioning of a Digital Video Broadcast-Terrestrial (DVB-T) program on a DVB-T device to a corresponding Digital Video Broadcast-Handheld (DVB-H) program on a DVB-H device according to an embodiment.

FIG. 7 shows a flow chart for transitioning a Digital Video Broadcast-Handheld (DVB-H) program from a DVB-H receiver of a device with both DVB-H and DVB-T receivers to a corresponding Digital Video Broadcast-Terrestrial (DVB-T) program of a DVB-T receiver in the device according to an embodiment.

FIG. 8 shows a signal flow diagram for user-initiated transitioning of a Digital Video Broadcast-Handheld (DVB-H) program from a DVB-H device to a corresponding Digital Video Broadcast-Terrestrial (DVB-T) program on a DVB-T device according to an embodiment.

FIG. 9 shows a signal flow diagram for automatically-initiated transitioning of a Digital Video Broadcast-Handheld (DVB-H) program from a DVB-H device to a corresponding Digital Video Broadcast-Terrestrial (DVB-T) program on a DVB-T device according to an embodiment.

### DETAILED DESCRIPTION

A digital video broadcast transition method and device allows a streaming digital video program to be transferred from one digital device broadcast receiver to another across digital video broadcast formats. Initially, a first digital video broadcast receiver is receiving a first digital video broadcast program. If a second digital video broadcast receiver capable of receiving a digital video broadcast program corresponding to the first digital video broadcast program is available to the user, the second digital video broadcast receiver is enabled. For example, a user may have a mobile device receiving news programming via a Digital Video Broadcast-Handheld (DVB-H) service. If the user gets near a digital television capable of receiving corresponding news programming via a Digital Video Broadcast-Terrestrial (DVB-T) service, the digital television is enabled and tuned to the corresponding DVB-T news programming. The transition from one digital video broadcast receiver to another digital video broadcast receiver can be implemented manually by the user or automatically via a user preference profile. The transition can be made gradually by having both receivers running simultaneously for a predetermined non-zero time period before releasing digital video broadcasting resources of the first device or can be made abruptly by setting the predetermined time period to zero seconds. Thus, a user can smoothly transition from digital video broadcasting content using a first digital video broadcasting system to corresponding digital video broadcasting content using a second digital video broadcasting system.

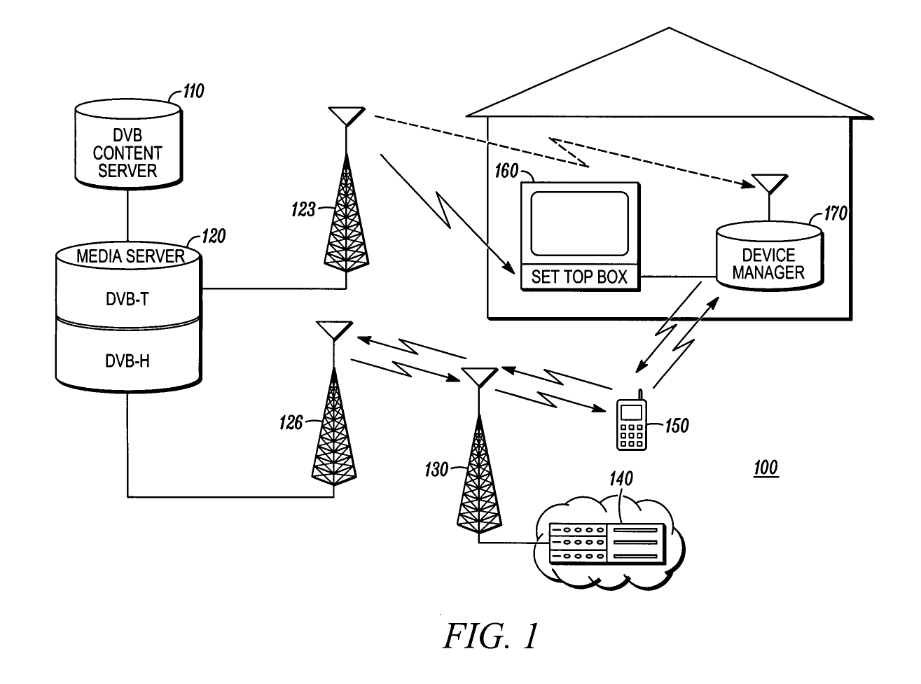

FIG. 1 shows a system 100 for transitioning a digital video broadcast according to an embodiment. In this system 100, a digital video broadcast content server 110 has or has access to digital video content (programs) such as news broadcasts, sporting events, comedy programming, history shows, and the like. A media server 120 takes the content from the content server and formats it for compatibility with a particular wireless access technology. For example, media server 120 formats the content for compatibility with the Digital Video Broadcast-Terrestrial (DVB-T) wireless access technology and sends the DVB-T signals using a first antenna 123. In this example, the media server 120 also format the same content for compatibility with the Digital Video Broadcast-Handheld (DVB-H) wireless access technology and sends the DVB-H signals using a second antenna 126.

Following the DVB-H signals, after being broadcast from the second antenna 126, a third antenna 130 that is part of a cellular network 140 receives the DVB-H signals and re-transmits the DVB-H signals through the cellular network. The DVB-H signals from the media server 120 to the cellular network 140 could alternately be sent by a wire line. A user equipment (UE) 150, such as a mobile station (MS), mobile device, laptop computer with cellular connection, or cellular telephone, with a DVB-H receiver receives the DVB-H signals and displays the program (content) to a user. Note that the DVB-H path has a cellular return channel that allows the UE 150 to communicate to the media server 120 via the various antennas and networks. The cellular return channel allows the user to select programs and respond during interactive programs.

Following the DVB-T signals, after being broadcast from the first antenna 123, the DVB-T signals can be directly received by a DVB-T receiver 160 such as a set top box for a digital television. Alternately (shown in dashed line), DVB-T signals can be received by a DVB-T receiver that is connected to a device manager 170 in a home network or the like. The device manager 170 may also incorporate a wireless local area network (WLAN), or the like, that is capable of receiving commands from a UE 150 with a compatible transceiver. For the DVB-T path, the DVB-T receiver can receive multiple channels and tune to the desired program (content). If the DVB-T receiver is a set top box, the television program shown on the digital television is controlled by tuning the set top box to a particular channel. If the DVB-T receiver is connected to the device manager 170, the television program shown on the digital television is controlled by the device manager 170, which also controls the tuning of the DVB-T receiver.

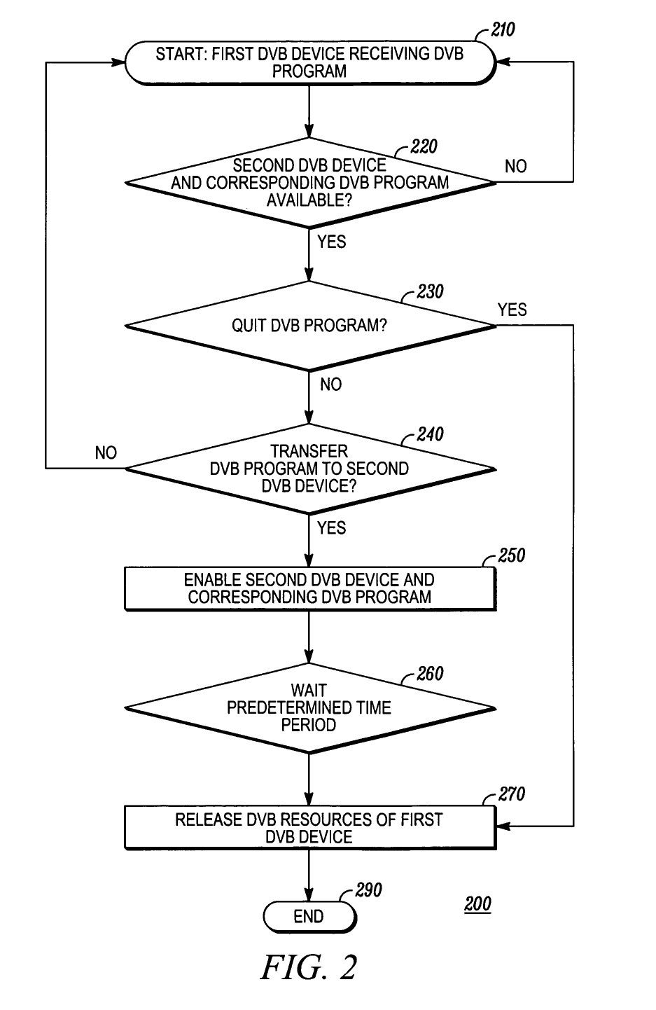

FIG. 2 shows a general flow chart 200 for transitioning a digital video broadcast according to an embodiment. Initially in step 210, a first digital video broadcast device is receiving a digital video broadcast program. In step 220, the first digital video broadcast device determines whether a second digital video broadcast device and a digital video broadcast program corresponding in content to the first digital video broadcast program is available. The determination of whether a second digital video broadcast device is available in step 220 can be made through the use of wired or wireless discovery of other devices and, optionally, through the use of a user profile. Regarding the determination of whether a corresponding digital video broadcast is available, because the same content is usually broadcast in both the DVB-T format and the DVB-H format (refer to FIG. 1), a DVB-T program usually has corresponding content in a concurrent DVB-H program and vice versa. Additionally, the ability to receive the same DVB-T or DVB-H format program on the second digital video broadcast device can be determined by the device manager 170, if the media server 120 provides this information to the device manager 170. If no other digital video broadcast device is available or no corresponding digital video broadcast program is available, the flow returns to step 210.

If a second digital video broadcast device is available and a corresponding digital video broadcast program is available, step 230 determines if the user would like to quit receiving the digital video broadcast program. For example, a user might want to quit receiving a digital video broadcast program upon returning home in order to give her full attention to her family. If so, step 270 releases the digital video broadcast resources of the first digital video broadcast device and the flow ends in step 290. An indication of quitting can be as simple as the user pressing an “OFF” button on the first digital video broadcast device or can be complicated and involve setting-up a user profile or using a location determination service to indicate that reception of the digital video broadcast program should be discontinued.

If the user would like to continue receiving the digital video broadcast program, step 240 determines whether the digital video broadcast program should be transferred to the second digital video broadcast device. This may involve looking up the second digital video broadcast device in a user preference profile or the like. If the user would like to continue receiving the digital video broadcast program on the first digital video broadcast device, the flow returns to step 210. If the user would like to transfer the program to the second device, step 250 enables the second digital video broadcast device and the corresponding digital video broadcast program.

After the second digital video broadcast device is enabled and set to the corresponding digital video broadcast program, step 260 causes the first digital video broadcast device to wait a predetermined amount of time before the digital video broadcast resources of the first digital video broadcast device are released in step 270. Step 260 allows for a warm-up time on the second digital video broadcast device (if needed) and also provides a transition time where both digital video broadcast devices are “ON” and tuned to corresponding digital video broadcast programs to allow the user time to shift attention from the first digital video broadcast device to the second digital video broadcast device. Although it is envisioned that the predetermined time period will be one to five minutes in length, the predetermined time period can be set to 0 seconds if no transition time is desired or longer than a few 20 minutes if desired.

After the digital video broadcast resources of the first digital video broadcast device are released, the flow ends in step 290 and the first digital video broadcast device is free to start receiving another digital video broadcast program or to exit the digital video broadcast reception mode. If the first digital video broadcast device is User Equipment, exiting DVB-H mode reduces the power consumption of the UE and extends its battery life while allowing the user to continue watching the digital video broadcast program on the second digital video broadcast device.

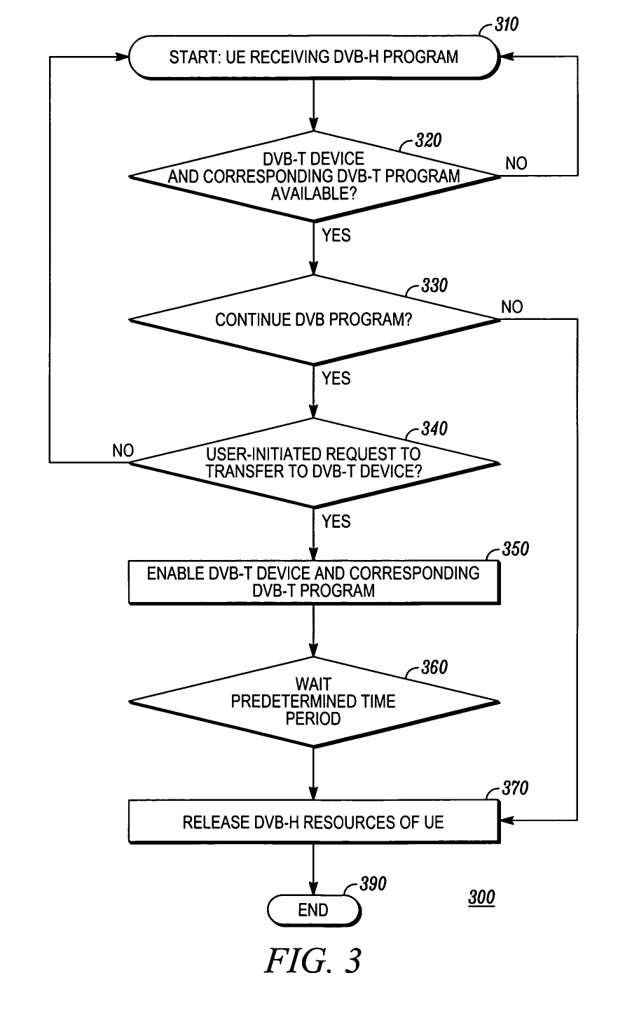

FIG. 3 shows a flow chart 300 for user-initiated transitioning of a Digital Video Broadcast-Handheld (DVB-H) program on a User Equipment (UE) with a DVB-H receiver to a corresponding Digital Video Broadcast-Terrestrial (DVB-T) program on a DVB-T device according to an embodiment. This flow chart 300 is a specific application of the general flow chart 200 shown in FIG. 2. In this specific application, a user can manually transition a DVB-H program on her UE to a corresponding DVB-T program on her digital television.

In step 310, a UE in DVB-H mode is receiving a DVB-H program. In step 320, the UE determines whether a DVB-T device is available and a DVB-T program corresponding to the DVB-H program is also available. If they are not available, the flow returns to step 310. If they are available, step 330 determines whether the user would like to continue receiving the digital video broadcast program. Note that in step 330, the program content is of importance and not the format of the program. If the user does not desire to continue watching the program, step 370 releases the DVB-H resources of the UE and the flow ends in step 390. At this point, the user may cause the UE to select a different digital video broadcast program or the user may cause the UE to exit DVB-H mode.

If the user wishes to continue receiving the digital video broadcast program, step 340 determines if the user initiated a transfer of the digital video broadcast program from the UE to the DVB-T device. Such as transfer can be initiated by pressing a key on the UE, scrolling to an appropriate menu option, or using voice control of the UE. If no transfer is desired, the flow returns to step 310 and the user continues to receive the DVB-H program on the UE. If a transfer is desired, step 350 enables the DVB-T device and the corresponding DVB-T program. Then, step 360 causes the UE to wait a predetermined amount of time (including waiting no time) before step 370 releases the DVB-H resources of the UE and the flow ends in step 390.

By transitioning a digital video broadcast program from DVB-H on a UE to DVB-T on her digital television, the user is saving battery resources on the UE and reducing the use of bandwidth and other wireless resources. The user is also being cost-effective by transferring from a per-minute charge on the UE to a flat-fee charge on the digital television. Finally, the user is experiencing a better video broadcast because the digital television is receiving a higher data-stream video broadcast and presumably has a larger display and better audio capabilities.

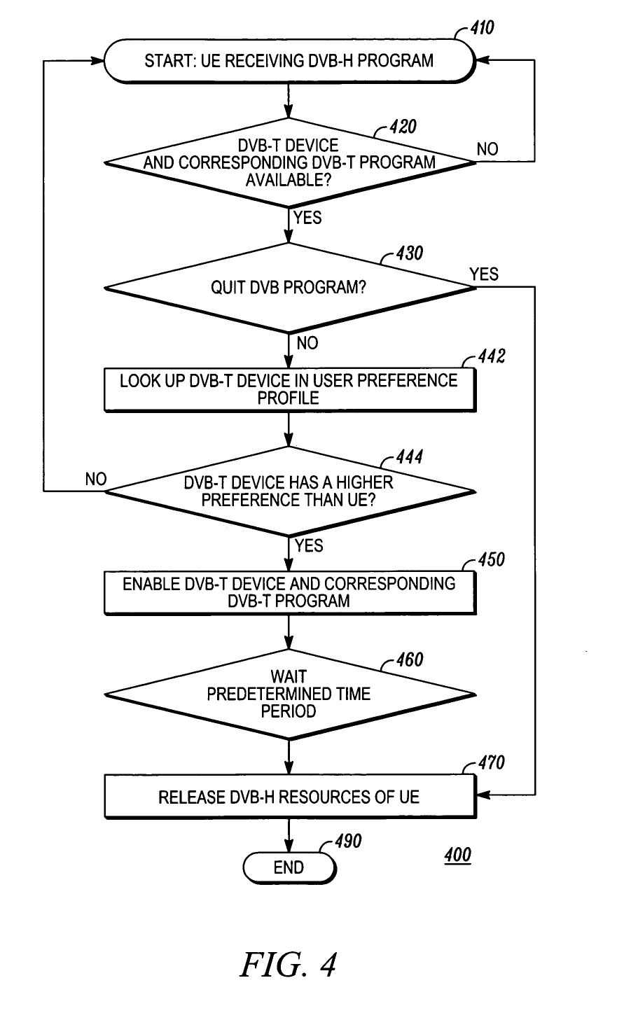

FIG. 4 shows a flow chart 400 for automatically-initiated transitioning a Digital Video Broadcast-Handheld (DVB-H) program on a User Equipment (UE) with a DVB-H receiver to a corresponding Digital Video Broadcast-Terrestrial (DVB-T) program on a DVB-T device according to an embodiment. This flow chart 400 is a specific application of the general flow chart 200 shown in FIG. 2 and is very similar to the flow chart 300 shown in FIG. 3. In this specific application, a user can automatically transition a DVB-H program on her UE to a corresponding DVB-T program on her digital television. This flow chart 400 assumes a user preference profile. Such as the user preference profiles that are currently being discussed and standardized in the Wireless Application Protocol Forum (WAP Forum) as a specification called User Agent Profile (UAProf). Other types of user preference profiles can be used, and they are being used here to automatically determine whether a user of the UE would like to transfer a digital video broadcast program from one digital video broadcast device to another digital video broadcast device. The user preference profile can be set to automatically prefer one type of receiver (e.g., DVH-T receiver) over another type of receiver (e.g., DVB-H receiver) or alter receiver preferences based on time-of-day, location of the digital video broadcast devices, individual video programs, and many other factors.

In step 410, a UE in DVB-H mode is receiving a DVB-H program. In step 420, the UE determines whether a DVB-T device is available and a DVB-T program corresponding to the DVB-H program is also available. If they are not available, the flow returns to step 410. If they are available, step 430 determines whether the user would like to quit receiving the digital video broadcast program. The step 430 determination can be made manually (e.g., by the user pressing an “OFF” button) or automatically by consulting a user preference profile stored in the UE. If the user desires to quit watching the program, step 470 releases the DVB-H resources of the UE and the flow ends in step 490.

If the user wishes to continue receiving the digital video broadcast program, step 442 looks up the DVB-T device in the user preference profile. If step 444 determines that the DVB-T device has a lower preference than the UE in the user preference profile, the UE automatically determines that no transfer of the program should occur and the flow returns to step 410. If step 444 determines that the DVB-T device has a higher preference than the UE according to the user preference profile, the UE enables the DVB-T device and the corresponding DVB-T program in step 450. After the UE enables the DVB-T device and DVB-T program, the UE waits for a predetermined amount of time (where the predetermined amount of time could be 0 seconds) in step 460 and releases the DVB-H resources of the UE in step 470 before ending the flow in step 490.

Automatically-initiated transitioning of a digital video broadcast program is especially convenient when a user has a routine and regularly transfers digital video broadcast programs from one device to another based on factors that can be formalized into a user preference profile. In addition to manually-initiated transitioning and automatically-initiated transitioning, there is an opportunity to implement a hybrid of the two. For example, a hybrid could include consulting a user preference profile and, if the second digital video broadcast device is not found in the user preference profile, presenting to the user the question of whether to transition a digital video broadcast program to the second digital video broadcast device in order to receive instructions for manually-initiated transitioning.

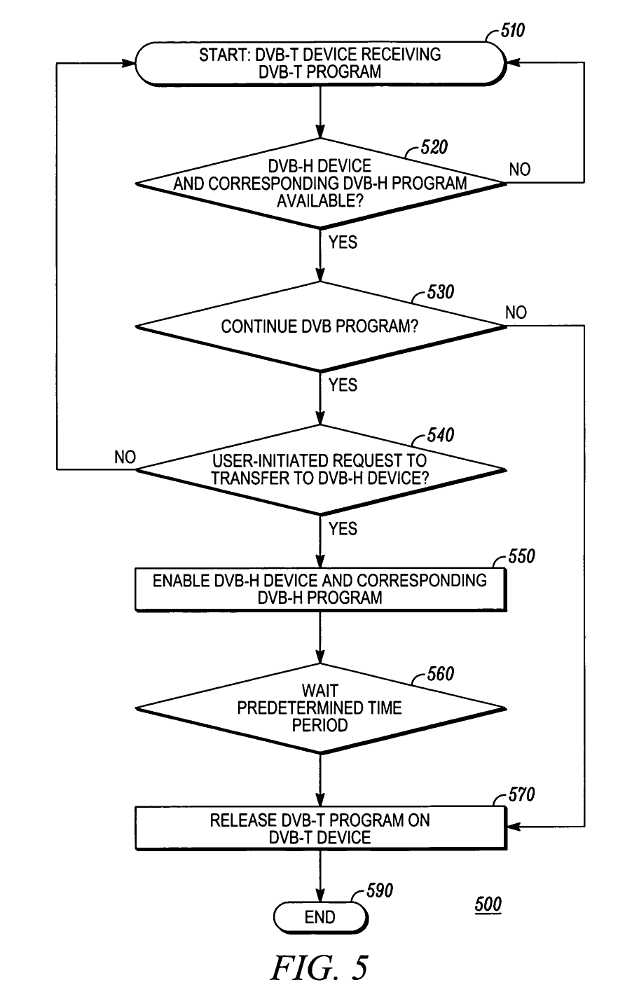

FIG. 5 shows a flow chart 500 for user-initiated transitioning of a Digital Video Broadcast-Terrestrial (DVB-T) program from a DVB-T device to a corresponding Digital Video Broadcast-Handheld (DVB-H) program on a DVB-H device according to an embodiment. This flow chart 500 is a specific application of the general flow chart 200 shown in FIG. 2. In this specific application, a user can manually transition a DVB-T program on a digital television to a corresponding DVB-H program on a UE.

In step 510, a DVB-T device such as a digital television is receiving a DVB-T program. In step 520, a device manager 170 determines whether a DVB-H device is available and a DVB-H program corresponding to the DVB-T program is also available through a media server 120. A DVB-H device could be a UE or a laptop computer equipped with hardware for a DVB-H mode. If they are not available, the flow returns to step 510. If they are available, step 530 determines whether the user would like to continue receiving the digital video broadcast program. Note that in step 530, the program content is of importance and not the format of the program. If the user does not desire the continue watching the program, step 570 releases the DVB-T resources of the DVB-T device and the flow ends in step 590. The user can indicate her desire to discontinue the program by pressing an “OFF” button of the DVB-T device or selecting a different DVB-T program or “digital television channel.”

If the user wishes to continue receiving the digital video broadcast program, step 540 determines if the user initiated a transfer of the digital video broadcast program from the DVB-T device to the DVB-H device. If no transfer is desired, the flow returns to step 510 and the user continues to receive the DVB-T program on the DVB-T device. If a transfer is desired, step 550 enables the DVB-H device and the corresponding DVB-H program. Then, step 560 causes the DVB-T device to wait a predetermined amount of time (where the predetermined amount of time could be “no time”) before step 570 releases the DVB-T resources of the DVB-T device and the flow ends in step 590.

By transitioning a digital video broadcast program from DVB-T on a DVB-T device (such as a digital television) to a DVB-H program on a UE or laptop computer, the user is able to take advantage of a portable digital video broadcast device and continue receiving a digital video broadcast program while in transit or while in a location where she does not have control over DVB-T devices. Although the DVB-H signal quality may not be as good as the corresponding DVB-T signal quality, or the display size or audio capability of the DVB-H device might be inferior to that of the DVB-T device, the user has already indicated that she would like to continue watching the program and it is assumed that a lower quality program is preferred to no program at all.

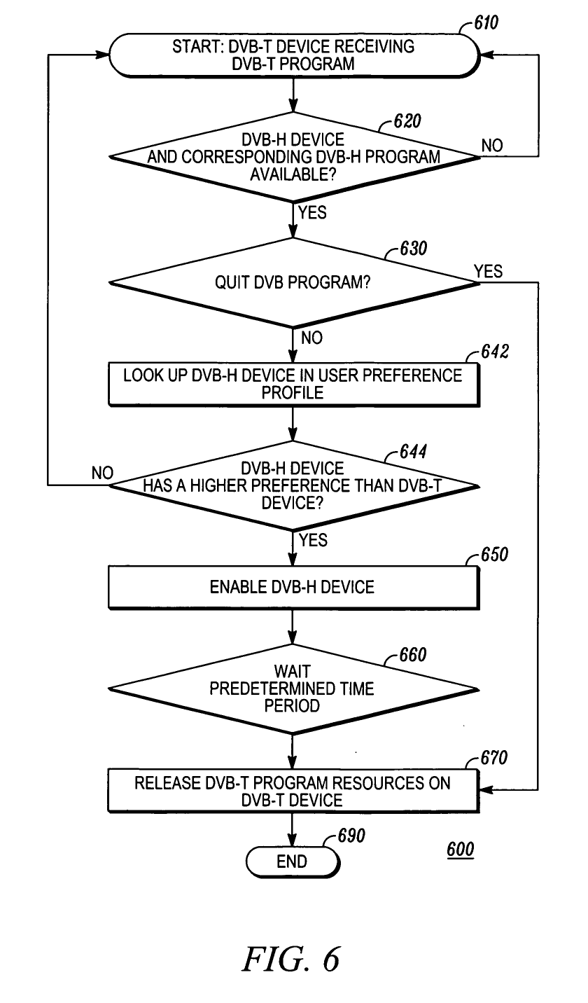

FIG. 6 shows a flow chart 600 for automatically-initiated transitioning of a Digital Video Broadcast-Terrestrial (DVB-T) program on a DVB-T device to a corresponding Digital Video Broadcast-Handheld (DVB-H) program on a DVB-H device according to an embodiment. This flow chart 600 is a specific application of the general flow chart 200 shown in FIG. 2 and is very similar to the flow chart 500 shown in FIG. 5. In this specific application, a user can automatically transition a DVB-T program on a digital television to a corresponding DVB-H program on a UE or laptop computer with DVB-H capabilities. This flow chart 600, like the flow chart 400 in FIG. 4, assumes a user preference profile such as the user preference profiles that are currently being discussed and standardized in the Wireless Application Protocol Forum (WAP Forum) as a specification called User Agent Profile (UAProf. Other types of user preference profiles can be used, and they are being used here to automatically determine whether a user of the DVB-T device would like to transfer a digital video broadcast program from one digital video broadcast device to another digital video broadcast device. The user preference profile can be set to automatically prefer one type of receiver (e.g., DVH-T receiver) over another type of receiver (e.g., DVB-H receiver) or alter receiver preferences based on time-of-day, location of the digital video broadcast devices, available video content, and many other factors.

In step 610, a DVB-T device such as a digital television is receiving a DVB-T program. In step 620, a device manager 170 determines whether a DVB-H device is available and a DVB-H program corresponding to the DVB-T program is also available through a media server 120. A DVB-H device could be a UE or a laptop computer equipped with hardware for a DVB-H mode. If they are not available, the flow returns to step 610. If they are available, step 630 determines whether the user would like to continue receiving the digital video broadcast program. Note that in step 630, the program content is of importance and not the format of the program. If the user desires to quit receiving the program, step 670 releases the DVB-T resources of the DVB-T device and the flow ends in step 690. The user can indicate her desire automatically by programming the user preference profile of the DVB-T device or the device manager or alternately the user can indicate her desire manually by pressing an “OFF” button of the DVB-T device or selecting a different DVB-T program or “digital television channel.”

If the user wishes to continue receiving the digital video broadcast program, step 642 looks up the DVB-H device in the user preference profile. If step 644 determines that the DVB-H device has a lower profile than the DVB-T device in the user preference profile, the DVB-T device automatically determines that no transfer of the program should occur and the flow returns to step 610. If step 644 determines that the DVB-H device has a higher preference than the DVB-T device according to the user preference profile, the DVB-T device enables the DVB-H device and the corresponding DVB-H program in step 650. After the DVB-T device enables the DVB-H device and DVB-H program, the DVB-T device waits for a predetermined amount of time (where the predetermined amount of time could be 0 seconds) in step 660 and releases the DVB-T resources of the DVB-T device in step 670 before ending the flow in step 690.

By automatically transitioning a digital video broadcast program from DVB-T on a DVB-T device (such as a digital television) to a DVB-H program on a UE or laptop computer, the user is able to take advantage of a portable digital video broadcast device and continue receiving a digital video broadcast program while in transit or while in a location where she does not have control over DVB-T devices. Although a DVB-T device may normally be preferred, a user preference profile can be programmed to prefer a DVB-H device if the user has habits that can be formalized in the user preference profile. For example, a user can program a user preference profile to give a higher preference to a UE with DVB-H capabilities during the times-of-day and days-of-week when she normally commutes or is waiting for a bus or train. As another example, a user can program a user preference profile to give a higher preference to a UE with DVB-H capabilities when the UE is outside of a particular geographic area. Such automatically-initiated transitioning can be very convenient for users with regular habits that can be programmed into the user preference profile.

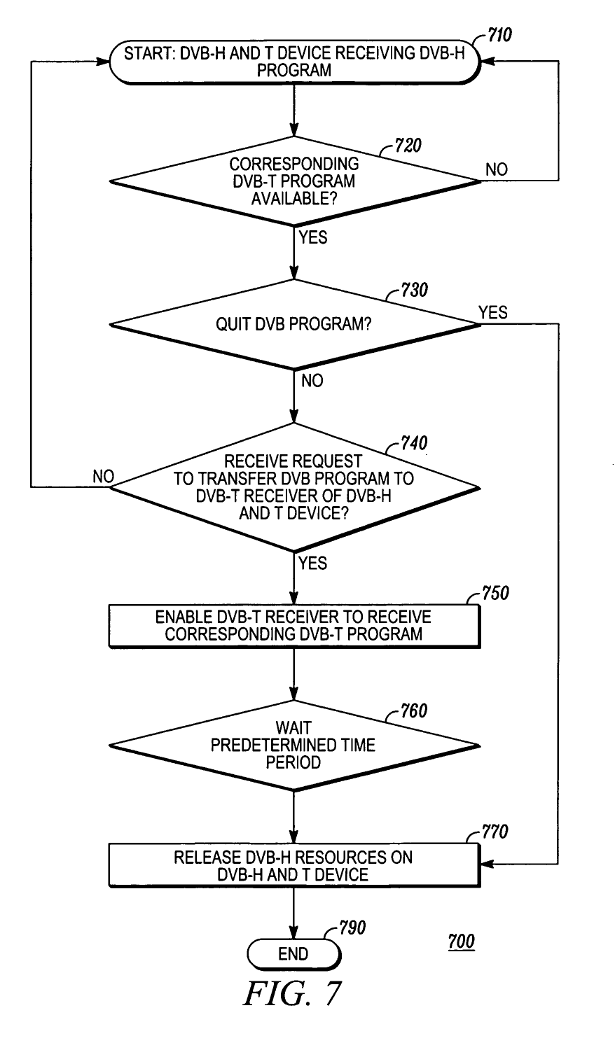

FIG. 7 shows a flow chart 700 for transitioning a Digital Video Broadcast-Handheld (DVB-H) program from a DVB-H receiver of a device with both DVB-H and DVB-T receivers to a corresponding Digital Video Broadcast-Terrestrial (DVB-T) program of a DVB-T receiver in the device according to an embodiment. This flow chart 700 is a specific application of the general flow chart 200 shown in FIG. 2. In this specific application, a user can automatically or manually transition a DVB-H program received on her laptop computer to a corresponding DVB-T program on her laptop computer. This specific application is useful when the user is in locations where the received signal strength of DVB-T signals is not equivalent to the received signal strength of corresponding DVB-H signals.

In step 710, a device with both DVB-T and DVB-H capabilities is in DVB-H mode and is receiving a DVB-H program. Such as device can be a laptop computer. In step 720, the laptop computer determines whether a DVB-T program corresponding to the DVB-H program is also available. If no corresponding DVB-T program is available, the flow returns to step 710. If a corresponding program is available, step 730 determines whether the user would like to continue receiving the digital video broadcast program. Note that step 730 can implicitly determine that the user would like to continue the program if the user does not indicate that she would like to quit the program. If the user indicates a desire to quit receiving the program, step 770 releases the DVB-H resources of the laptop computer and the flow ends in step 790. At this point, the user may cause the laptop computer to select a different digital video broadcast program or the user may cause the laptop computer to exit DVB-H mode.

If the user wishes to continue receiving the digital video broadcast program, step 740 determines if there is a request to initiate a transfer of the digital video broadcast program from the DVB-H receiver to the DVB-T receiver. This transfer request can be received manually from the user or automatically by consulting a user preference profile stored in the laptop. If no transfer is desired, the flow returns to step 710 and the user continues to receive the DVB-H program. If a transfer is desired, step 750 enables the DVB-T receiver to receive the corresponding DVB-T program. Because the DVB-T program is being receiving using the same device as the DVB-H program, the waiting time period in step 760 can be set to zero, and step 770 immediately releases the DVB-H resources of the laptop computer before the flow ends in step 790.

Although transitioning a digital video broadcast program from DVB-H to DVB-T on a laptop computer may not affect the power consumption rate significantly and does not affect the display size and audio capabilities of the laptop computer, the user may receive a higher quality video and audio signal through the DVB-T format than the DVB-H format. Also, due to the tuning capabilities of a DVB-T receiving, it may be easier to change digital television channels while receiving a DVB-T signal than while receiving a DVB-H signal. Alternately, a user may enjoy the features enabled by a cellular return channel and prefer DVB-H programming over corresponding DVB-T programming on the laptop computer. In either case, the flow chart 700 allows for manual or automatic transitioning of a digital video broadcast program from the DVB-H format to the DVB-T format. The flow chart 200 can also be applied to a situation where it is desired to transfer a digital video broadcast program from DVB-T format to DVB-H format.

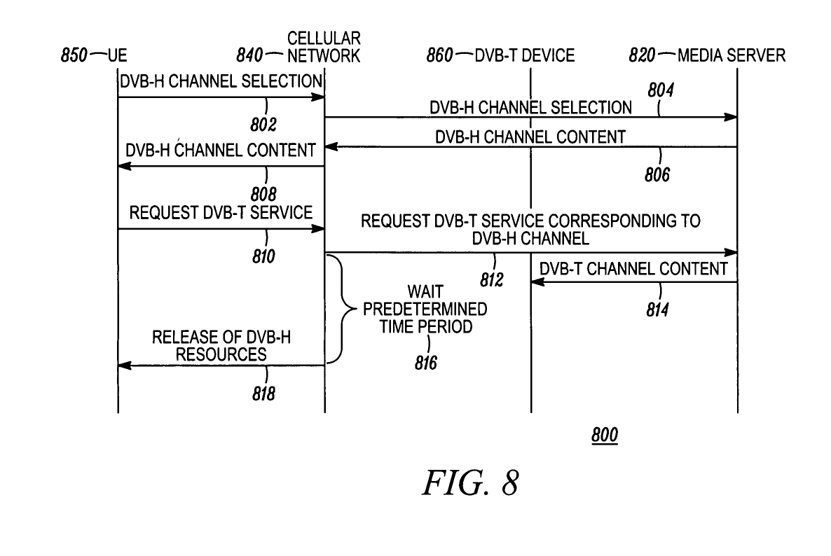

FIG. 8 shows a signal flow diagram 800 for user-initiated transitioning of a Digital Video Broadcast-Handheld (DVB-H) program from a DVB-H device to a corresponding Digital Video Broadcast-Terrestrial (DVB-T) program on a DVB-T device according to an embodiment. This signal flow diagram 800 corresponds to the flow chart 300 shown in FIG. 3 and has correspondence to the system 100 shown in FIG. 1. FIG. 8 shows signals going to and from the UE 850 (see UE 150 in FIG. 1), the cellular network 840 (see cellular network 140 shown in FIG. 1), the DVB-T device 860 (see DVB-T receiver 160 shown in FIG. 1), and the media server 820 (see media server 120 shown in FIG. 1).

Step 310 of FIG. 3 assumes that a UE is receiving a DVB-H program. FIG. 8 shows the initial set-up of the DVB-H program on a UE being accomplished using four basic signal flows. The UE 850 transmits a DVB-H channel selection to the cellular network 840 using signal 802. The cellular network 840 forwards the DVB-H channel selection to the media server 820 using signal 804. The media server 820 responds to the cellular network 840 with digital video broadcast content corresponding to the selected channel in DVB-H format in signal 806. And the cellular network 840 forwards the digital video broadcast content to the UE 850 in DVB-H format using signal 808. Note that this is a very simplified signal flow diagram used to convey the initial step 310 in FIG. 3, and many other signals are being transmitted and could be transmitted.

After the UE is receiving a DVB-H program (see step 310 in FIG. 3), the UE determines that a DVB-T device is available and that a corresponding DVB-T program is available (see step 320 in FIG. 3). The UE receives an indication to continue the digital video broadcast program (see step 330 in FIG. 3), which could be implicitly assumed if the user does not indicate a desire to quit the digital video broadcast program, and the user initiates a request to transfer the program to the DVB-T device.

After the user initiates a request to transfer the digital video broadcast program from the UE to the DVB-T device, the UE 850 transmits a request for DVB-T service signal 810 to the cellular network 840. The request signal 810 includes information regarding the current DVB-H program currently being received by the UE 850. See step 350 in FIG. 3. The cellular network 840 forwards the request to the media server 820 using signal 812, and the media server responds by transmitting DVB-T signals 814 to the DVB-T device 860 including channel content corresponding to the DVB-H program currently being received by the UE 850. In the meantime, the cellular network 840 waits a predetermined time period 816 (see step 360 in FIG. 3) before releasing the DVB-H resources of the UE 850 using signal 818.

In this signal flow diagram 800, it is assumed that the DVB-T device 860 has digital broadcast channel selection capabilities and that an appropriate channel can be selected either through the media server 820 or through the UE 850 acting as a remote controller to the DVB-T device. Thus, the UE 850 and the DVB-T device 860 will have corresponding digital video broadcast programming showing during the predetermined time period and then the DVB-H programming will end while the DVB-T programming will continue.

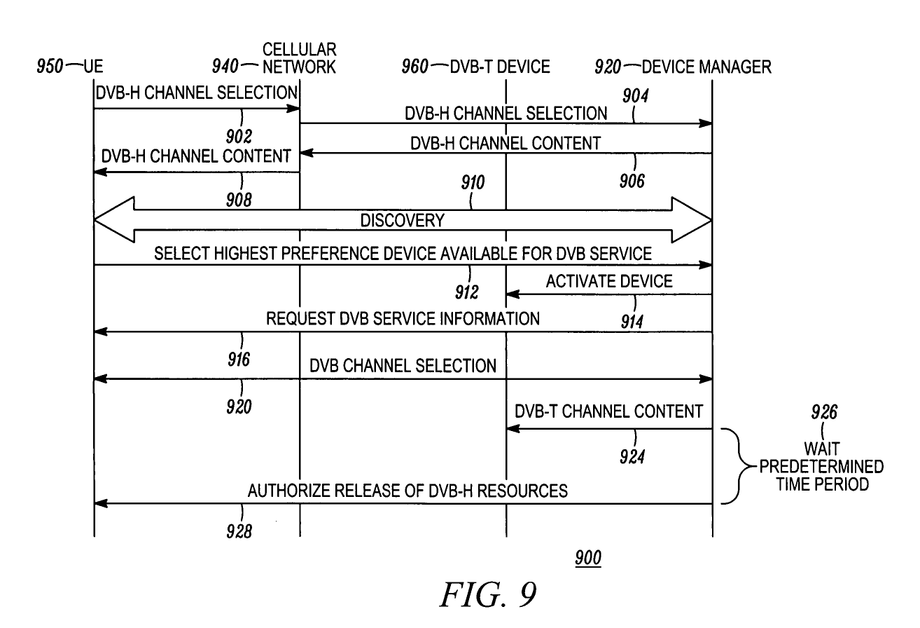

FIG. 9 shows a signal flow diagram 900 for automatically-initiated transitioning of a Digital Video Broadcast-Handheld (DVB-H) program from a DVB-H device to a corresponding Digital Video Broadcast-Terrestrial (DVB-T) program on a DVB-T device according to an embodiment. This signal flow diagram 900 corresponds to the flow chart 400 shown in FIG. 4 and has a correspondence to the system 100 shown in FIG. 1. FIG. 9 shows signals going to and from the UE 950 (see UE 150 in FIG. 1), the cellular network 940 (see cellular network 140 shown in FIG. 1), the DVB-T device 960 (see DVB-T receiver 160 shown in FIG. 1), and the device manager 970 (see device manager 170 shown in FIG. 1).

Step 410 of FIG. 4 assumes that a UE is receiving a DVB-H program. FIG. 9 shows the initial set-up of the DVB-H program on a UE being accomplished using four basic signal flows. The UE 950 transmits a DVB-H channel selection to the cellular network 940 using signal 902. The cellular network 940 forwards the DVB-H channel selection to the device manager 970 using signal 904. The device manager 970 responds to the cellular network 940 with digital video broadcast content corresponding to the selected channel in DVB-H format in signal 906. And the cellular network 940 forwards the digital video broadcast content to the UE 950 in DVB-H format using signal 908. The device manager 970 provides the tuning capabilities for the DVB-T device 960. In this embodiment, it is contemplated that a device manager 970 is a part of a WiFi network such as a home wireless network or an office wireless network.

After the UE is receiving a DVB-H program (see step 410 in FIG. 4), the UE determines that a DVB-T device is available and that a corresponding DVB-T program is available (see step 420 in FIG. 4). Step 420 in FIG. 4 can be accomplished with various WiFi and other wireless device discovery methods. During the wireless device discovery 910, the UE compiles (or receives) a list of devices on the WiFi network that are capable of receiving DVB-T signals. The UE receives an indication to continue the digital video broadcast program (see step 430 in FIG. 4), which could be implicitly assumed if the user does not indicate a desire to quit the digital video broadcast program, and UE looks up the one or more devices identified during discovery 910 in the user preference profile. If there is a discovered device with a higher preference than the UE (see step 444 of FIG. 4), the UE automatically sends to the device manager 970 a request to transfer the program to the highest preference DVB device using signal 912 (see step 450 in FIG. 4).

The device manager 970 then transmits a signal 914 to activate the selected device. Next, the device manager 970 requests from the UE 950 service information relating to the DVB-H program currently being received on the UE using signal 916. The UE 950 responds to the device manager 970 with the DVB-H program information in signal 920. The device manager 970 tunes to the corresponding DVB-T channel and sends the channel content to the DVB-T device 960 using signal 924. After a predetermined amount of time 926, the device manager 970 authorizes the release of DVB-H resources on the UE 950 using signal 928.

In this signal flow diagram 900, it is assumed that the device manager 970 has digital broadcast channel selection capabilities and that any DVB-T device 960 channel selection capabilities are being over-ridden by the device manager 970. This signal flow diagram 900 shows how a digital video broadcast program can be transferred from DVB-H format on a UE to a DVB-T format on a DVB-T device in a WiFi network.

Although the general flow chart 200 shown in FIG. 2 has been tailored to five specific applications, the general flow chart 200 can be tailored to additional situations not shown. Also, the signal flow diagrams shown in FIG. 8 and FIG. 9 have only been shown for two of the five specific applications. Additional signal flow diagrams can easily be created for the remaining three specific situations, as well as other situations, without undue experimentation.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

As understood by those in the art, the various devices shown in FIG. 1 include processors that execute computer program code to implement the methods described herein. Embodiments include computer program code containing instructions embodied in tangible media, such as floppy diskettes, CD-ROMs, hard drives, or any other computer-readable storage medium, wherein, when the computer program code is loaded into and executed by a processor, the processor becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

We claim:

1. A method for transitioning a digital video broadcast program comprising:
receiving a first digital video broadcast program on a first device using digital video broadcasting resources;
determining that a second device capable of receiving a digital video broadcast program corresponding to the first video broadcast program is available; and
enabling the second device and the corresponding digital video broadcast program.

2. The method of claim 1 wherein the first device is a user equipment having a digital video broadcast mode.

3. The method of claim 1 wherein enabling the second device and the corresponding digital video broadcast program comprises:
receiving a user-initiated request to transfer the first digital video broadcast program on the first device to the corresponding digital video broadcast program on the second device.

4. The method of claim 1 wherein enabling the second device and the corresponding digital video broadcast program comprises:
receiving an identification of the second device;
looking up the second device in a user preference profile stored on the first device; and
enabling the second device and the corresponding digital video broadcast program only if the identification of the second device has a higher preference than the first device in the user preference profile.

5. The method of claim 1 further comprising:
releasing digital video broadcasting resources of the first device after enabling the second device and the corresponding digital video broadcast program.

6. The method of claim 5 wherein releasing digital video broadcasting resources of the first device comprises waiting a predetermined time period before releasing digital video broadcasting resources.

7. The method of claim 6 wherein the predetermined time period is zero seconds.

8. The method of claim 6 wherein the predetermined time period is a non-zero number of seconds.

9. The method of claim 1 wherein the first digital video broadcast program is a Digital Video Broadcast-Handheld (DVB-H) formatted program and the first device receives the DVB-H formatted program using a DVB-H receiver

10. The method of claim 9 wherein the digital video broadcast program corresponding to the first video broadcast program is a Digital Video Broadcast-Terrestrial (DVB-T) formatted program with content corresponding to the DVB-H formatted program and the second device is capable of receiving the DVB-T formatted program using a DVB-T receiver.

11. The method of claim 10 wherein the DVB-H receiver and the DVB-T receiver are within a single unit.

12. The method of claim 10 wherein enabling comprises:
transmitting from the first device to a cellular network a request for DVB-T service corresponding to the DVB-H formatted program.

13. The method of claim 10 wherein enabling comprises:
transmitting DVB-T channel selection information to a device manager.

14. A first device capable of transitioning a digital video broadcast program to a second digital video broadcasting receiver comprising:
a first digital video broadcast receiver;
a memory containing a user preference profile with a prioritized list of digital video broadcasting receivers; and
a transmitter for enabling a second digital video broadcasting receiver having a higher priority than the first digital video broadcast receiver of the first device.

15. The first device of claim 14 wherein the first digital video broadcast receiver is a Digital Video Broadcast-Handheld (DVB-H) receiver.

16. The first device of claim 14 wherein the transmitter is a cellular transmitter.

17. The first device of claim 14 wherein the transmitter is a wireless local area network transmitter.

18. The first device of claim 14 wherein the user preference profile further contains variables for altering the prioritized list of digital video broadcasting receivers.

19. The first device of claim 18 wherein a variable includes time-of-day.

20. A method for a cellular network to transition a digital video broadcast program from a first device to a second device comprising:
receiving a first digital video broadcast channel selection from the first device;
transmitting the first digital video broadcast channel selection to a media server;
receiving digital video broadcast channel content corresponding to the first digital video broadcast channel selection;
transmitting the digital video broadcast channel content to the first device;
receiving, from the first device, a request for digital video broadcast service on a second device;
transmitting the request for digital video broadcast service and transmitting a second digital video broadcast channel selection corresponding to the first digital video broadcast channel selection;
waiting a predetermined period of time; and
releasing digital video broadcast resources from the first device.
